(19) United States
(12) Patent Application Publication
(10) Pub. No.: US 2025/0193224 A1
(43) Pub. Date: Jun. 12, 2025

(54) RISK ANALYSIS BASED ON DEVICE CONTEXT

(71) Applicant: DELL PRODUCTS L.P., Round Rock, TX (US)

(72) Inventors: Karunakar Palicherla Reddy, Austin, TX (US); Charles D. Robison, Buford, GA (US); Michael S. Gatson, Austin, TX (US)

(73) Assignee: DELL PRODUCTS L.P., Round Rock, TX (US)

(21) Appl. No.: 18/536,413

(22) Filed: Dec. 12, 2023

(51) Int. Cl. H04L 9/40

(52) U.S. Cl. CPC H04L 63/1433; H04L 63/107

(57) ABSTRACT

Techniques for analyzing risk based on device context are described. One example method includes authenticating a user for access to the computer system while the computer system is located at a particular location; in response to authenticating the user, capturing an image of an environment of the computer system at the particular location; generating a device context based on the captured image; determining a risk score based on the device context, wherein the risk score is associated with the computer system and the particular location and represents a determined risk of allowing the device to access a network while located at the particular location.

### TECHNICAL FIELD

The present disclosure relates in general to information handling systems, and more particularly to techniques for analyzing risk based on device context.

### BACKGROUND OF THE INVENTION

Many computer systems can detect the physical presence of a user near a computer system. This ability to detect user presence can allow the system to be contextually aware of user's proximity to the system, the user's attention to the system, the environment in which the user is using the system, and other information. For example, a system can automatically wake up from a low power state in response to detecting the presence of a user, and can initiate facial recognition to verify the user's identity to quickly log them into the system. A system can also lock itself when it detects that no user is present. User presence can be detected, for example, by analyzing captured video signals from a low power camera device, audio signals from a microphone, or other signals or combinations of signals.

Presence detection techniques can also be used to detect other types of objects besides human users in proximity to the computer system. For example, the computer system may detect the presence of other objects its environment, such as other computing devices, walls and other structural components of its environment, persons speaking outside the field of view of a camera, and the like.

### SUMMARY OF THE INVENTION

In accordance with embodiments of the present disclosure, a method for analyzing risk based on device context including authenticating a user for access to the computer system while the computer system is located at a particular location; in response to authenticating the user, capturing an image of an environment of the computer system at the particular location; generating a device context based on the captured image; determining a risk score based on the device context, wherein the risk score is associated with the computer system and the particular location and represents a determined risk of allowing the device to access a network while located at the particular location.

In some implementations, the particular location is a first location, the image is a first image, the device context is a first device context, and the risk score is a first risk score, the method further includes authenticating the user for access to the computer system while the computer system is located at a second location different than the first location; in response to authenticating the user, capturing a second image of an environment of the computer system at the second location; generating a second device context based on the captured second image; determining a second risk score based on the second device context, wherein the second risk score is associated with the computer system and the second location.

In some cases, generating the device context includes identifying potential security risks depicted in the captured image.

In some implementations, the potential security risks include one or more of unauthenticated persons able to view a display of the computer system, video recording devices positioned to capture video information output by the computer system, or audio recording devices positioned to capture video information output by the computer system.

In some cases, the method further includes after determining the risk score, authenticating the user for access to the computer system while the computer system is located at the particular location; in response to authenticating the user, capturing an updated image of an environment of the computer system at the particular location; updating the device context based on the updated image; and updating the risk score associated with the computer system and the particular location based on the updated device context.

In some implementations, the method further includes after determining the risk score, authenticating the user for access to the computer system while the computer system is located at the particular location; in response to authenticating the user, capturing an updated image of an environment of the computer system at the particular location; identifying the device context based on the updated image, wherein the identifying is performed by a machine learning model trained to identify the device context based on images of the environment of the computer system.

In some cases, the method further includes after determining the risk score, determining that the risk score exceeds a risk threshold; and in response, denying the computer system access to the network from the particular location.

In accordance with embodiments of the present disclosure, a system for analyzing risk based on device context performs operations including authenticating a user for access to the computer system while the computer system is located at a particular location; in response to authenticating the user, capturing an image of an environment of the computer system at the particular location; generating a device context based on the captured image; determining a risk score based on the device context, wherein the risk score is associated with the computer system and the particular location and represents a determined risk of allowing the device to access a network while located at the particular location.

In accordance with embodiments of the present disclosure, an article of manufacture includes a non-transitory, computer-readable medium having computer-executable instructions thereon that are executable by a processor of a computer system to perform operations for analyzing risk based on device context including authenticating a user for access to the computer system while the computer system is located at a particular location; in response to authenticating the user, capturing an image of an environment of the computer system at the particular location; generating a device context based on the captured image; determining a risk score based on the device context, wherein the risk score is associated with the computer system and the particular location and represents a determined risk of allowing the device to access a network while located at the particular location.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example system for risk analysis based on device context, in accordance with embodiments of the present disclosure;

FIG. 3 illustrates a block diagram of an example system for risk analysis based on device context, in accordance with embodiments of the present disclosure;

FIG. 4 illustrates a flow chart of an example process for risk analysis based on device context, in accordance with embodiments of the present disclosure.

### DETAILED DESCRIPTION OF THE INVENTION

In a network ecosystem, every device that joins the network represents a possible vector for security breaches. The risk associated with allowing a device to access the network can be quantified in the form for a risk score, as described herein. One factor that contributes to the risk associated with allowing a device to access the network is the physical environment or “context” of the device when accessing the network. Since many network devices (e.g., laptops, smartphones, etc.) are portable, a device may access the network from many different physical locations, each one representing a different context with different security risks. The present disclosure described techniques for analyzing and quantifying this risk associated with different contexts, and adapting network policies based on the particular context from which a device is attempting to access the network.

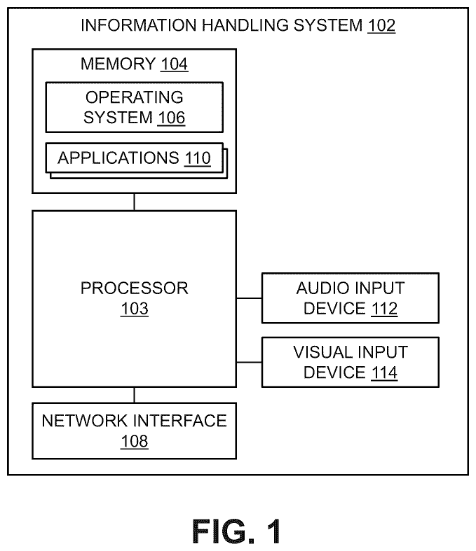

Preferred embodiments and their advantages are best understood by reference to FIGS. 1 through 4, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, and a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Memory 104 may also have stored thereon one or more applications 110. Each of the applications 110 may comprise any program of executable instructions (or aggregation of programs of executable instructions) configured to make use of the hardware resources of the information handling system 102, such as memory, processor time, disk space, input and output devices (e.g., 112, 114), and the like. In some implementations, the applications 110 may interact with the operating system 106 to make of the hardware resources, and the operating system 106 may manage and control the access of the applications 110 to these resources (as described above).

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In some embodiments, information handling system 102 may include more than one processor 103. For example, one such processor 103 may be a CPU, and other processors 103 may include various other processing cores such as application processing units (APUs) and graphics processing units (GPUS).

Information handling system 102 further includes an audio input device 112 communicatively coupled to processor 103. Audio input device 112 can be any device (e.g., a microphone) operable to detect audible signals (i.e., sound waves) in the environment external to the information handling system 102, and convert those audible signals into electrical signals. These electrical signals representing the detected audible signals can be provided to the processor 103 where they can be analyzed and interpreted, at the direction of applications 110 and/or operating system 106. In some cases, the audio input device 112 can be integrated into the information handling system 102, such as in the case of a built-in microphone. The audio input device 112 may also be an external device communicatively coupled to the information handling system 102, such as an external microphone connected via Universal Serial Bus (USB).

Information handling system 102 further includes an visual input device 114 communicatively coupled to processor 103. Visual input device 114 can be any device operable to detect electromagnetic radiation, such as visible light, and convert it into representative electrical signals. These electrical signals representing the detected electromagnetic radiation can be provided to the processor 103 where they can be analyzed and interpreted, for example at the direction of applications 110 and/or operating system 106. In some cases, the visual input device 114 can be complementary metal-oxide-semiconductor (CMOS) sensor, a charge coupled device (CCD) sensor, or another type of sensor operable to detect electromagnetic radiation. In some implementations, the visual input device 114 may be configured to detect a particular range of wavelengths of electromagnetic radiation, such as the visual light range, the ultraviolet range, the infrared range, or combinations of these and other ranges. In some cases, the visual input device 114 may be a low power camera device that monitors the environment while the information handling system 102 remains in a lower power state. In some implementations, the visual input device 114 can be integrated into the information handling system 102, such as in the case of a built-in camera. The visual input device 114 may also be an external device communicatively coupled to the information handling system 102, such as an external camera connected via USB.

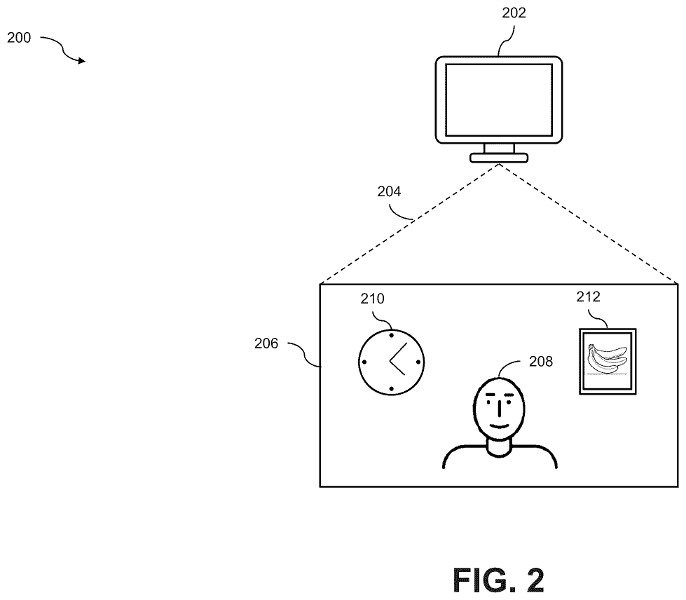

FIG. 2 illustrates a block diagram of an example system 200 for risk analysis based on device context, in accordance with embodiments of the present disclosure. System 200 represents a computer system 202 in a first context (i.e., a first location). A user 208 is shown within a captured image 206, along with objects 210, 212.

As discussed elsewhere herein, when the user 208 logs in to computer system 202, the computer system 202 captures an image 206 of the environment, for example, using an integrated camera (e.g., visual input device 114 in FIG. 1). The captured image 206 depicts the user 208, along with a clock 210 and a painting 212. The computer system 202 may analyze the captured image 206, and identify the features it contains (e.g., the user 208, the clock 210, and the painting 212) to create a context. The computer system 202 may then determine whether any of the features in the created context represent a security threat, and assign a risk score to this particular context. In the present case, the computer system 202 may determine that none of the features in the captured image represent a potential security or privacy risk, since they include the registered user 208, and two innocuous objects 210 and 212.

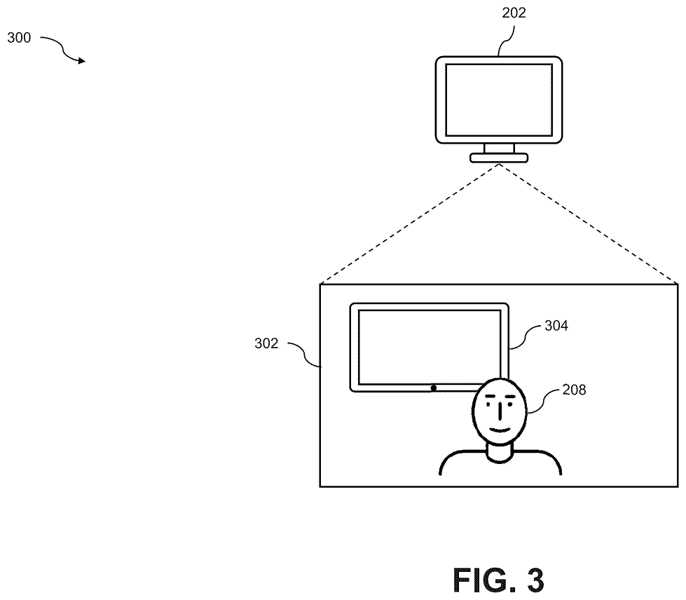

FIG. 3 illustrates a block diagram of an example system 300 for risk analysis based on device context, in accordance with embodiments of the present disclosure. System 200 represents the computer system 202 in a second context (i.e., a second location) different than the first. The user 208 is shown within a captured image 302, in front of a television 304. The computer system 202 may analyze the captured image 302, and identify the features it contains (e.g., the user 208, the television 304) to create another context associated with this second location. The computer system 202 may then determine whether any of the features in the created context represent a security threat, and assign a risk score to this particular context. In the present case, the computer system 202 may determine that the television 304 represents a potential security threat, given its position over user 208's shoulder with a view of a display screen of the computer system 202. The television 304 is most likely network enabled, and may include a camera for video conferencing. If an attacker was able to compromise television 304, they could not only view the user 208's display surreptitiously, but they could also attempt to compromise computer system 202 and access the wider network through computer system 202's connection. Other potential security threats include, but are not limited to, video recording devices, audio recording devices, smartphones, tablets, or any other device capable of recording video or audio. Potential security threats also include unauthorized persons with a view of the display of the computer 202, crowded environments with many persons, open windows with a view of the screen, mirrors reflecting a view of the screen, and the like.

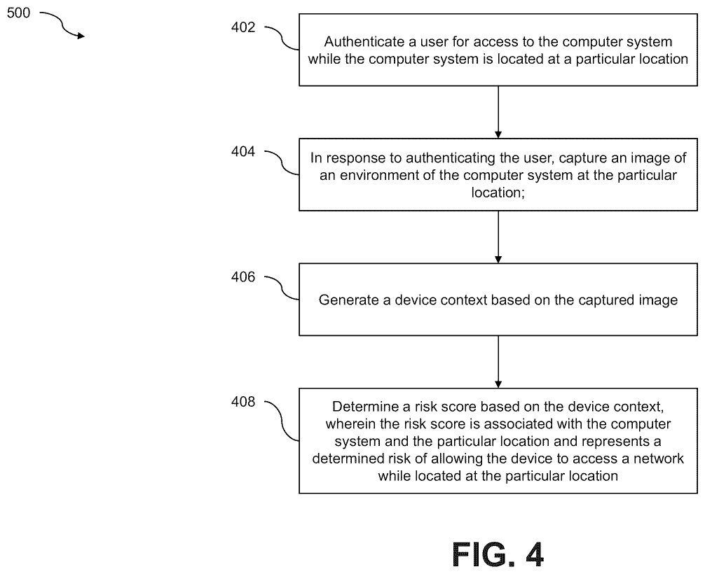

FIG. 4 illustrates a flow chart of an example process 400 for risk analysis based on device context, in accordance with embodiments of the present disclosure.

At 402, a user is authenticated for access to the computer system while the computer system is located at a particular location. At 404, in response to authenticating the user, an image is captured of an environment of the computer system at the particular location. At 406, a device context is generated based on the captured image. At 408, a risk score is determined based on the device context, wherein the risk score is associated with the computer system and the particular location and represents a determined risk of allowing the device to access a network while located at the particular location.

In some implementations, the particular location is a first location, the image is a first image, the device context is a first device context, and the risk score is a first risk score, the process 400 further includes authenticating the user for access to the computer system while the computer system is located at a second location different than the first location; in response to authenticating the user, capturing a second image of an environment of the computer system at the second location; generating a second device context based on the captured second image; determining a second risk score based on the second device context, wherein the second risk score is associated with the computer system and the second location.

In some cases, generating the device context includes identifying potential security risks depicted in the captured image.

In some implementations, the potential security risks include one or more of unauthenticated persons able to view a display of the computer system, video recording devices positioned to capture video information output by the computer system, or audio recording devices positioned to capture video information output by the computer system.

In some cases, the operations further include after determining the risk score, authenticating the user for access to the computer system while the computer system is located at the particular location; in response to authenticating the user, capturing an updated image of an environment of the computer system at the particular location; updating the device context based on the updated image; and updating the risk score associated with the computer system and the particular location based on the updated device context.

In some implementations, the process 400 further includes after determining the risk score, authenticating the user for access to the computer system while the computer system is located at the particular location; in response to authenticating the user, capturing an updated image of an environment of the computer system at the particular location; identifying the device context based on the updated image, wherein the identifying is performed by a machine learning model trained to identify the device context based on images of the environment of the computer system.

In some cases, the process 400 further includes after determining the risk score, determining that the risk score exceeds a risk threshold; and in response, denying the computer system access to the network from the particular location.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for analyzing risk of access based on device context, the method comprising:
authenticating, by a computer system including at least one processor, a user for access to the computer system while the computer system is located at a particular location;
in response to authenticating the user, capturing, by the computer system, an image of an environment of the computer system at the particular location;
generating, by the computer system, a device context based on the captured image;
determining, by the computer system, a risk score based on the device context, wherein the risk score is associated with the computer system and the particular location and represents a determined risk of allowing the device to access a network while located at the particular location.

2. The method of claim 1, wherein the particular location is a first location, the image is a first image, the device context is a first device context, and the risk score is a first risk score, the method further comprising:
authenticating, by the computer system, the user for access to the computer system while the computer system is located at a second location different than the first location;
in response to authenticating the user, capturing, by the computer system, a second image of an environment of the computer system at the second location;
generating, by the computer system, a second device context based on the captured second image;
determining, by the computer system, a second risk score based on the second device context, wherein the second risk score is associated with the computer system and the second location.

3. The method of claim 1, wherein generating the device context includes identifying potential security risks depicted in the captured image.

4. The method of claim 1, wherein the potential security risks include one or more of unauthenticated persons able to view a display of the computer system, video recording devices positioned to capture video information output by the computer system, or audio recording devices positioned to capture video information output by the computer system.

5. The method of claim 1, further comprising:
after determining the risk score, authenticating, by the computer system, the user for access to the computer system while the computer system is located at the particular location;
in response to authenticating the user, capturing, by the computer system, an updated image of an environment of the computer system at the particular location;
updating, by the computer system, the device context based on the updated image; and
updating, by the computer system, the risk score associated with the computer system and the particular location based on the updated device context.

6. The method of claim 1, further comprising:
after determining the risk score, authenticating, by the computer system, the user for access to the computer system while the computer system is located at the particular location;
in response to authenticating the user, capturing, by the computer system, an updated image of an environment of the computer system at the particular location;
identifying, by the computer system, the device context based on the updated image, wherein the identifying is performed by a machine learning model trained to identify the device context based on images of the environment of the computer system.

7. The method of claim 1, further comprising:
after determining the risk score, determining that the risk score exceeds a risk threshold; and
in response, denying the computer system access to the network from the particular location.

8. A system for analyzing risk of access based on device context comprising:
a computer system including at least one processor and a memory, and configured to perform operations including:
authenticating a user for access to the computer system while the computer system is located at a particular location;
in response to authenticating the user, capturing an image of an environment of the computer system at the particular location;
generating a device context based on the captured image;
determining a risk score based on the device context, wherein the risk score is associated with the computer system and the particular location and represents a determined risk of allowing the device to access a network while located at the particular location.

9. The system of claim 8, wherein the particular location is a first location, the image is a first image, the device context is a first device context, and the risk score is a first risk score, the operations further comprising:
authenticating the user for access to the computer system while the computer system is located at a second location different than the first location;
in response to authenticating the user, capturing a second image of an environment of the computer system at the second location;
generating a second device context based on the captured second image;
determining a second risk score based on the second device context, wherein the second risk score is associated with the computer system and the second location.

10. The system of claim 8, wherein generating the device context includes identifying potential security risks depicted in the captured image.

11. The system of claim 8, wherein the potential security risks include one or more of unauthenticated persons able to view a display of the computer system, video recording devices positioned to capture video information output by the computer system, or audio recording devices positioned to capture video information output by the computer system.

12. The system of claim 8, the operations further comprising:
after determining the risk score, authenticating the user for access to the computer system while the computer system is located at the particular location;
in response to authenticating the user, capturing an updated image of an environment of the computer system at the particular location;
updating the device context based on the updated image; and
updating the risk score associated with the computer system and the particular location based on the updated device context.

13. The system of claim 8, the operations further comprising:
after determining the risk score, authenticating the user for access to the computer system while the computer system is located at the particular location;
in response to authenticating the user, capturing an updated image of an environment of the computer system at the particular location;
identifying the device context based on the updated image, wherein the identifying is performed by a machine learning model trained to identify the device context based on images of the environment of the computer system.

14. The system of claim 8, the operations further comprising:
after determining the risk score, determining that the risk score exceeds a risk threshold; and
in response, denying the computer system access to the network from the particular location.

15. An article of manufacture comprising a non-transitory, computer-readable medium having computer-executable instructions thereon that are executable by a processor of a computer system to perform operations for analyzing risk of access based on device context, the operations comprising:
authenticating a user for access to the computer system while the computer system is located at a particular location;
in response to authenticating the user, capturing an image of an environment of the computer system at the particular location;
generating a device context based on the captured image;
determining a risk score based on the device context, wherein the risk score is associated with the computer system and the particular location and represents a determined risk of allowing the device to access a network while located at the particular location.

16. The article of claim 15, wherein the particular location is a first location, the image is a first image, the device context is a first device context, and the risk score is a first risk score, the operations further comprising:
authenticating the user for access to the computer article while the computer system is located at a second location different than the first location;
in response to authenticating the user, capturing a second image of an environment of the computer system at the second location;
generating a second device context based on the captured second image;
determining a second risk score based on the second device context, wherein the second risk score is associated with the computer system and the second location.

17. The article of claim 15, wherein generating the device context includes identifying potential security risks depicted in the captured image.

18. The article of claim 15, wherein the potential security risks include one or more of unauthenticated persons able to view a display of the computer system, video recording devices positioned to capture video information output by the computer system, or audio recording devices positioned to capture video information output by the computer system.

19. The article of claim 15, the operations further comprising:
after determining the risk score, authenticating the user for access to the computer system while the computer system is located at the particular location;
in response to authenticating the user, capturing an updated image of an environment of the computer system at the particular location;
updating the device context based on the updated image; and
updating the risk score associated with the computer system and the particular location based on the updated device context.

20. The article of claim 15, the operations further comprising:
after determining the risk score, authenticating the user for access to the computer system while the computer system is located at the particular location;
in response to authenticating the user, capturing an updated image of an environment of the computer system at the particular location;
identifying the device context based on the updated image, wherein the identifying is performed by a machine learning model trained to identify the device context based on images of the environment of the computer system.
